(19) United States
(12) Patent Application Publication
(10) Pub. No.: US 2005/0074134 A1
(43) Pub. Date: Apr. 7, 2005

(54) Actuator assembly

(76) Inventor: David Henry Pearce, Birmingham (GB)

Correspondence Address: Fulbright & Jaworski, Twenty Ninth Floor, 865 South Figueroa, Los Angeles, CA, 90017-2571, US

(21) Appl. No.: 10/473,798

(22) PCT Filed: Apr. 3, 2002
(86) PCT No.: PCT/GB02/01537

(30) Foreign Application Priority Data
Apr. 3, 2001 (GB) 0108258.5

(51) Int. Cl. H04R 25/00

(52) U.S. Cl. 381/190

(57) ABSTRACT

An actuator assembly comprises a first member (6a,6b), a second member (4a,4b) and at least one connecting arm (10a,10b) of fixed length connecting the first and second members (6a,6b;4a,4b). The assembly also comprises an actuator (12,14) which is operably engaged with the first member (6a,6b) so as to be capable of applying a rotating force to the first member (6a,6b). In use, rotational movement of the first member (6a,6b) causes relative linear movement of the first and second members (6a,6b;4a,4b) along an axis. The invention also relates to a loudspeaker driver unit and a sensor incorporating the actuator assembly. In the sensor embodiments, the actuator is an electrical transducer.

The present invention relates, in a first aspect, to an actuator assembly in which a rotating force applied to a first member is converted into linear movement. The present invention also relates to loudspeaker driver units comprising such a device.

There are many devices (such as loudspeaker driver units and focussing assemblies for cameras and microscopes etc and CD and DVD players) into which linear actuator assemblies are incorporated. In such devices one or more of the following factors may be important: mass, power consumption, compactness and linearity of response. For example, in magnet-based loudspeaker driver units, a moving coil oscillates in a magnetic field generated by a permanent magnet. The magnet may make up as much as 90% of the mass of the driver unit, but serves no other purpose than to generate the magnetic field. Crystal loudspeaker driver units are also known. These incorporate a piezoelectric crystal which undergoes a change in thickness when subjected to a potential difference. When an alternating voltage is applied, the crystal undergoes bending oscillations which are transmitted to a speaker diaphragm. Crystal-based driver units are particularly suited to the generation of high frequencies, and a conventional loudspeaker may comprise an electrodynamic- and crystal-based driver unit in order to achieve a full range (20 Hz-20 kHz) frequency response.

Geophone sensors (see for example U.S. Pat. No. 4,152,692), used to detect seismic vibrations, basically comprise a coil suspended between a pair of springs and positioned around a strong magnet. Vertical linear travel of the coil due to seismic vibrations produces strong electrical signals in the coil. Such magnet-coil based devices are generally complex and relatively heavy and large.

An object of a first aspect of the present invention is to provide a novel linear actuator assembly which obviates or mitigates one or more disadvantages of known actuator assemblies. A further object of the present invention is to provide improved devices, such as a loudspeaker driver unit, incorporating such an assembly. An object of a second aspect of the present invention is to provide an improved vibration sensor.

According to the present invention, there is provided an actuator assembly comprising:—
(i) a first member,
(ii) a second member,
(iii) at least one connecting arm of fixed length connecting said first and second members, and
(iv) an actuator operably engaged with said first member so as to be capable of applying a rotating force to the first member,
   wherein in use, rotational movement of the first member causes relative linear movement of the first and second members along an axis.

Preferably, the first member and actuator are arranged so that the force applied by the latter causes the former to rotate in a plane substantially perpendicular to said axis.

The actuator is preferably a piezoelectric or electrostrictive transducer. Preferably, the actuator is in the form of a spiral having at least one half turn. It will be understood that the greater the number of turns for a given actuator, the greater the maximum angular actuation will be.

Examples of suitable piezoelectric materials include ceramic materials such as lead-zirconate-titanate (PZT) based systems or non-ceramic systems (eg. polymer based systems such as polyvinylidene fluoride). Particularly preferred compositions are those classified by the US Department of Defence under DOD STD-1376A type VI. An example of which is PZT-5H (sold by Morgan Electroceramics).

Preferably, the piezoelectric material has a lateral piezoelectric strain (d₃₁) coefficient greater than 200 pC/N. More preferably the d₃coefficient is no more than 350 pC/N. Preferably the elastic stiffness of the piezoelectric material is at least 65 GPa.

When a piezoelectric material is used it preferably has a bimorph or multimorph structure, although unimorph structures may be used.

If an electrostrictive material is used, it is preferably a ceramic material, and more preferably based on the lead magnesium niobate-lead titanate (PMN-PT) system.

Preferably, the first and second members are annular with differing diameters (“inner” and “outer” annular members) interconnected by at least two (but preferably three) connecting arms. Preferably, said arms are arranged symmetrically between said annular members. More preferably, said arms are arcuate. The first member may be the inner or outer member.

Preferably, the first and second members and said at least one connecting arm are of unitary construction. Such a construction in which inner and outer annular rings are interconnected by arcuate connecting arms will hereinafter be referred to as a “plate spring” or a “spiral arm spring”. Such springs are per se known and have been used in geophone sensor units.

It will be understood that when the inner and outer rings of a plate spring are moved apart along an axis perpendicular to the plane of the spring, there must be relative rotation of the inner and outer rings because the connecting arms are of fixed length. Consequently, if one ring is caused to rotate and the other is prevented from rotating, relative linear movement of the rings will be induced perpendicular to the plane of the spring.

It will also be understood from the foregoing that one of the first and second members may be mounted so as to prevent movement along the axis, in which case actuation will result in movement of the other member along the axis.

In a first series of embodiments, the first member is mounted so that linear movement along the axis is prevented, whereas the second member is mounted for linear movement along the axis.

In a preferred arrangement, the actuator (preferably in spiral form) is positioned inside the first (inner) annular member and secured thereto. Securement may be achieved by, for example, soldering, fusing, or bonding with adhesive. Suitable formations (eg. tabs or flanges) onto which to secure the actuator may be provided on the first member.

Alternatively, the actuator (preferably in spiral form) is positioned outside the first (outer) annular member and secured thereto. Such an arrangement permits the mounting of, for example, a lens inside the second (inner) annular member.

In a highly preferred embodiment, the actuator assembly comprises first and second plate springs whose outer annular rings are secured together (directly or indirectly, eg. by placing a stiffening ring or cylindrical collar therebetween), and first and second spiral actuators arranged to actuate the respective inner rings of the first and second plate springs wherein the actuators are oppositely orientated so that, in use, actuation of the first spiral actuator rotates the inner ring of the first plate spring in one direction about the axis, whereas simultaneous actuation of the second actuator rotates the inner ring of the second plate spring in the opposite direction about the axis by an equal amount, whereby to move the outer rings along the axis.

It will be readily understood that the outer rings can be moved in either direction along the axis depending on the polarity of the applied voltage.

In a very highly preferred embodiment, the outer rings are secured together and the inner rings are equidistantly spaced either side of the outer rings.

In a second series of embodiments, the second member is mounted so that linear movement along the axis is prevented, whereas the first member and actuator are mounted for linear movement along the axis.

The present invention also resides in a loudspeaker driver unit and loudspeaker comprising an actuator assembly in accordance with the present invention and an air piston driven by the actuator assembly to generate an acoustic wave. The air piston may be in the form of a hemisphere or a conical diaphragm. Alternatively, the loudspeaker driver unit may include a diaphragm which is oscillated by the actuator assembly to generate an acoustic wave.

It will be understood that if the actuator is in fact an electrical transducer, rotation of the transducer will result in the generation of an electrical signal in the transducer.

Thus, according to a second aspect of the present invention, there is provided a sensor comprising:—
(i) a first member,
(ii) a second member,
(iii) at least one connecting arm of fixed length connecting said first and second members and
(iv) a transducer operably engaged with said first member,
   wherein in use, relative linear movement of the first and second members along an axis causes rotational movement of the first member which is transmitted to said transducer whereby to generate an electrical signal in said transducer.

Said sensor corresponds closely to said actuator assembly, the primary difference being that in the former, relative linear movement is converted into rotational movement and subsequently into an electrical signal, whereas in the latter, actuated rotational movement is converted into relative linear movement. It will therefore be understood that the preferred features of the assembly of the first aspect are also preferred features of the sensor of the second aspect.

The sensor may be a vibration sensor, e.g. for detecting seismic vibrations.

Embodiments of the present invention will now be described by way of example only, with reference to the accompanying drawings in which:—

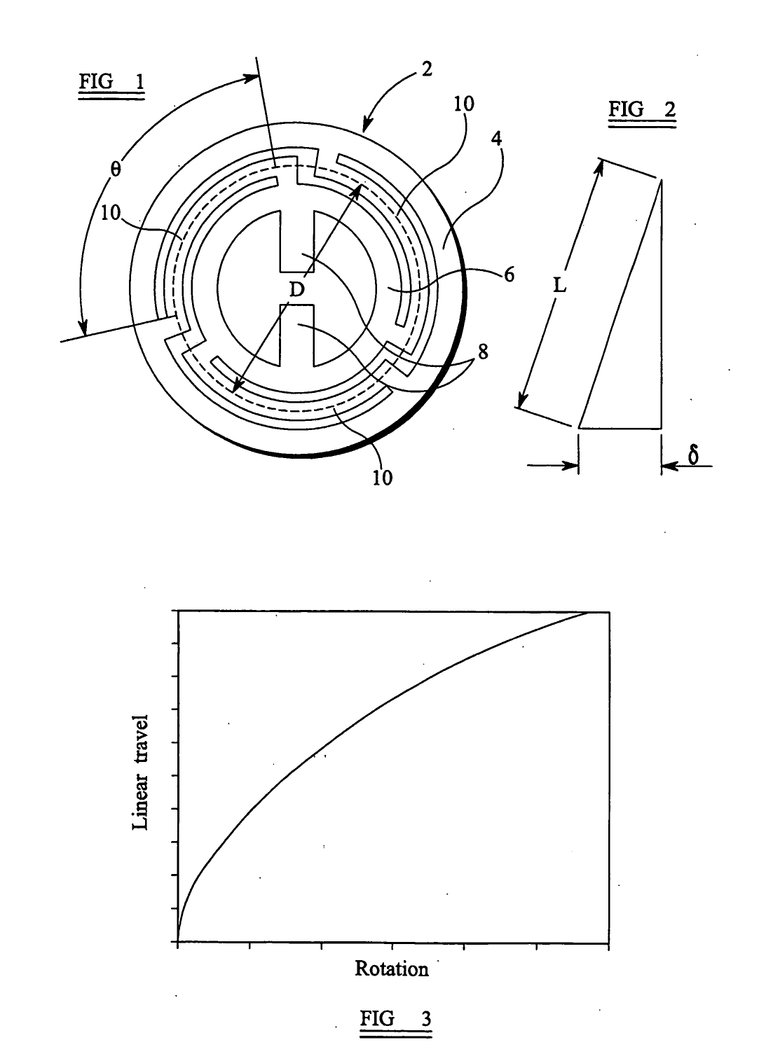

FIG. 1 is plan view of a plate spring suitable for use in the actuator assembly of the first aspect of the invention, or the sensor of the second aspect of the invention,

FIG. 2 shows the triangle formed between an arm of length L lying on a diameter D when the spring of FIG. 1 is offset by a displacement 6,

FIG. 3 is a graph of linear travel against relative rotation derived for the spring of FIG. 1,

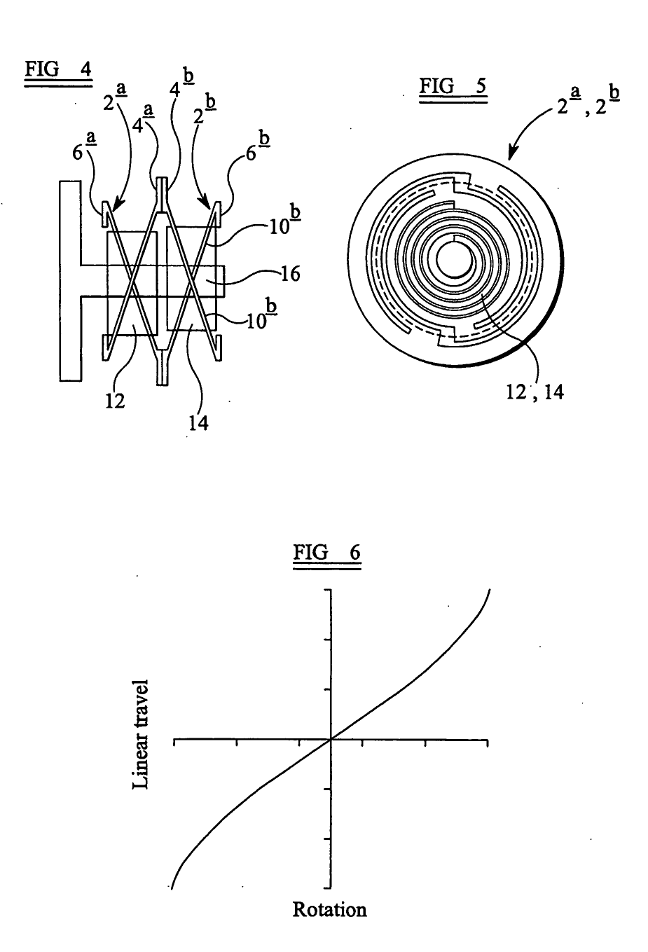

FIGS. 4 and 5 show an embodiment of an actuator assembly in accordance with the first aspect of the present invention,

FIG. 6 is a graph of linear travel against relative rotation derived for the embodiment of FIGS. 4 and 5.

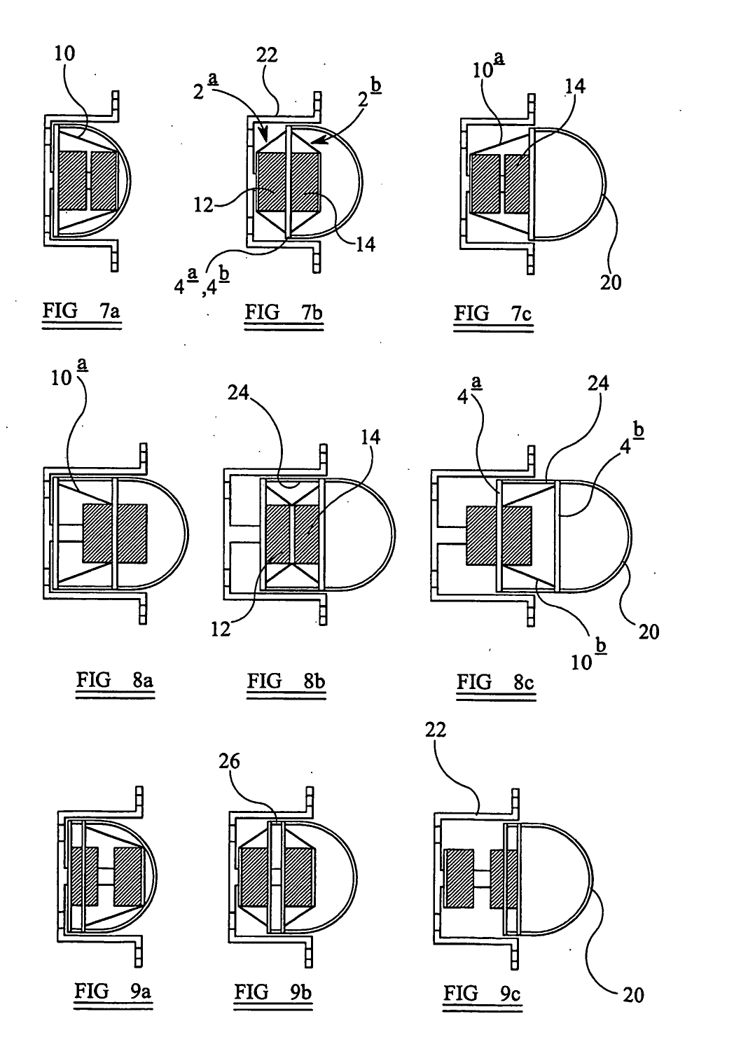

FIGS. 7a to 7c are schematic representations of a loudspeaker driver unit incorporating an actuator assembly in accordance with the first aspect of the present invention in an extreme inner (FIG. 7a), intermediate (FIG. 7b) and extreme outer (FIG. 7c) position,

FIGS. 8a to 8c correspond to FIGS. 7a to 7c for a stiffened loudspeaker driver unit incorporating an actuator assembly in accordance with the first aspect of the present invention,

FIGS. 9a to 9c correspond to FIGS. 7a to 7c for a partially stiffened loudspeaker driver unit incorporating an actuator assembly in accordance with the first aspect of the present invention, and

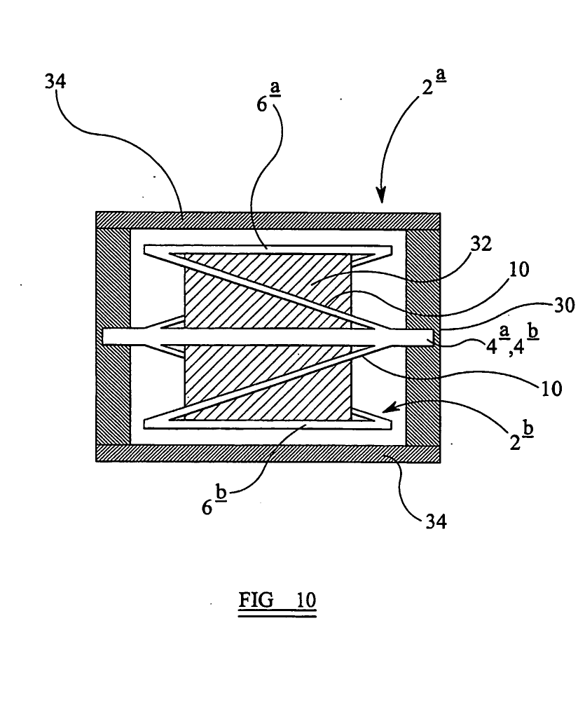

FIG. 10 is a schematic view of part of a vibration sensor in accordance with the second aspect of the invention.

Referring to FIG. 1, a plate spring 2 comprises a first (outer) annular ring 4 and a second (inner) annular ring 6, the first and second rings 4,6 being concentric (i.e. coplanar) in the rest position of the spring 2. A pair of tabs 8 angularly spaced by 180° extends radially inwardly from the inner ring 6. The first and second rings are connected by three part-annular connecting arms 10. Each arm 10 subtends an angle of 0 and lies on a circle of diameter D. The plate spring 2 is of unitary construction and fabricated from beryllium copper alloy. In use, the tabs 8 are bent out of the plane of the spring 2 and serve as mounting points for a spiral actuator (described below).

It will be understood that as the two rings 4,6 are moved relative to one another along an axis perpendicular to the plane of the spring 2, there must be relative rotation of the rings 4,6 to maintain the rings 4,6 in a parallel orientation. This is because the connecting arms 10 are of fixed length. An approximate relationship between the linear movement and the relative rotation can be derived as follows:—

The length of each arm 10 is given by

$$L = \frac{D θ}{2}$$

If the inner and outer rings 4,6 are displaced perpendicularly to the plane of the spring 2 relative to each other by a distance δ, the angle subtended by each arm 10 (as viewed in FIG. 1) must change. This can be calculated approximately by assuming that the arms 10 lie on the same diameter (D) and form perfect helical lines connecting the inner and outer rings 4,6.

FIG. 2 shows the triangle formed by the arc length L and the displacement 6. The projection of the arc on to the initial plane of the spring 2 is then given by

$$L = \frac{D}{2} ( θ - Δ θ )$$

where Δθ corresponds to the relative rotation of the inner and outer rings 4,6 of the spring 2 necessary for them to remain parallel, with L being constant.

The displacement δ can then be given as

$$θ = \frac{D}{2} \sqrt{Δ {θ}^{2} + 2 θ Δ θ}$$

This relationship is depicted in FIG. 3 from which it will be noted that at relatively large linear displacements, the relationship between linear travel and rotation is approximately linear. The present invention takes advantage of this effect which allows linear movement to be produced directly from a rotational actuation.

Referring to FIGS. 4 and 5, an embodiment of the actuator assembly comprises first and second identical plate springs 2a,2b, first and second identical piezoelectric ceramic actuators 12, 14 and a mounting post 16. The plate springs 2a,2b are similar to that described with reference to FIG. 1 (and the same reference numerals are used to denote corresponding structures, suffixed by “a” and “b” to denote the first and second springs respectively), but there are only two connecting arms 10.

Each actuator 12, 14 is formed from a tape of a lead-zirconate-titanate (PZT) composition having a bimorph structure which is wound into a spiral having 4 turns in the present embodiment. Such piezoelectric ceramic materials are particularly suited to the present invention because they can exhibit a lateral piezoelectric strain (d₃₁) coefficient as high as 350 pC/N, while possessing a flexural elastic modulus of over 60 Gpa. If only small actuation movements are required, these properties allow high forces to be generated from a small amount of material. This is useful in certain applications, such as in loudspeaker driver units as will be described below. The outer diameter of the actuator spirals 12, 14 corresponds to the inner diameter of the inner rings 6a,6b of the plate springs 2a,2b.

A Bimorph piezoelectric structure is formed from two layers of piezoelectric material, separated by a conductive central electrode. Electrodes are placed on the outer surfaces of the ceramic layers, and the layers are poled and actuated using these three electrodes such that the overall effect of the actuation is to expand one ceramic layer while causing the other to contract, through the effect of the d₃₁ coefficient, thus producing a uniform bending strain in the element.

Various methods for creating ceramic compositions suitable for use in the present invention are known, see for example EP01 83453, EP0288208 and N. Alford et al, Nature; v.330; pp 51-53. To form the required spiral actuator structure, it is most beneficial to first create the required Bimorph structure in a planar form. This may be done through the routes of printing and lamination. A green (unfired) ceramic tape is formed from PZT powder mixed with a polyvinyl butyral (PVB) binder and cyclohexanone solvent. In the present embodiment the formulation is 100 parts by weight of PZT to 6 parts PVB, to 7 parts cyclohexanone and 0.1 parts stearic acid, the stearic acid serving as a surfactant. The green tape is then printed with the internal electrode, which may be of platinum, silver or an alloy of silver and palladium, formed into a printable ink. In the present embodiment platinum is used (grade C51121D1 supplied by Gwent Electronic Materials, Pontypool). The printed tape is then laminated with another ceramic tape of the same type and thickness (in the present embodiment PZT-5H, each tape 0.35 mm thick in the green state). The lamination step may involve pressure and/or heat to achieve a strong bond across the electrode print. The outer electrodes are then printed in the same fashion as the internal electrode, and allowed to dry.

After the printing stage, the overall tape structure must be sufficiently flexible and plastic to be deformed into the required spiral actuator structure. This shaping may be achieved by using a tape formation route which includes a thermoplastic binder, in which case heat and pressure may be used to deform the tape into the required spiral. With a solvent and binder system as in the present embodiment, the presence of the solvent allows the material to remain plastically deformable prior to removal of the solvent through evaporation. An interleaving tape may be used, in order to maintain separation of the spiral turns during shaping. This material may be in the form of carbon, formed in the same manner as the ceramic tape. In the present embodiment 35 parts by weight of carbon black, 11 parts PVB and 12 parts cyclohexanone are used. After the plastic processing step, and after drying, if applicable, the carbon tape is removed along with the binder in the ceramic tape through slow heating up to 600° C. in air. Extra interleaving layers may be used between the PZT and the carbon layers to prevent the tapes adhering to each other while the solvent is still present. Suitable materials include polythene, preferably less than 50:m thick. This may be removed from the spirals after drying. The spiral form is then sintered in an enclosed crucible with sufficient excess PbO-containing material, such as lead zirconate, to prevent PbO loss from the piezoelectric material. After sintering, the thickness of the tapes is reduced to about 0.3 mm giving a total actuator thickness of 0.6 mm. Soldered electrical connections are then made to the three separate electrode layers, with a wire connected to each. The outer two layers of the tape are connected to a high voltage supply, and the device is placed in a heated oil bath at 120-130° C. A voltage equivalent to 2.5 kV/mm across the whole tape thickness is applied while the device is in the bath for 10 minutes. This process polarises the piezoelectric tape. After polarisation, the third electrode, connected to the central electrode layer, can be used to apply a field which is in opposite directions on each half of the tape. The outer two electrodes can therefore be connected together, and used as the ground electrode, while the central electrode can be used for the driving signal. For driving, the opposing electric fields generate bending in the tape.

Each of the actuator spirals 12, 14 is securely mounted onto the mounting post 16, each actuator 12, 14 being oppositely orientated relative to the other with the actuators 12, 14 spaced a short distance apart. The outer rings 4a,4b of the springs 2a,2b are securely soldered to opposite sides of a stiffening ring (not shown) which prevents warping of the outer rings 4a,4b. It should be noted that the springs 2a,2b are in the same orientation. Each spring 2a,2b is tensioned by moving the inner ring 6a,6b out of the initial plane of the spring 2a,2b. The inner ring 6a of the first spring 2a is moved towards the end of the first actuator 12 remote from the second actuator 14 where it is securely fixed via the tabs (8, FIG. 1) to the outer curved surface of the first actuator 12 by soldered joints. The tabs lie 180° apart so that the axial forces on the outer rings 4a,4b do not produce unbalanced forces on the actuator spirals 12, 14. The inner ring 6b of the second spring 2b is moved in the opposite direction (i.e. towards the end of the second actuator 14 remote from the first actuator 12) where it is secured to the curved surface of the second actuator 14 via the tabs (8, FIG. 1) to the outer curved surface of the second actuator 14 by soldered joints. As can be seen in FIG. 4, the soldered outer rings 4a,4b of the springs 2a,2b are equidistant from the respective inner rings 6a,6b.

In use, when an electrical signal is applied to both actuator spirals 12,14 in parallel via the respective inner and outer electrodes connected to a power source (not shown), the actuators 12, 14 “rotate” in opposite directions. The rotation of the first actuator 12 is transmitted to the inner ring 6a of the first spring 2a and the opposite rotation of the second actuator 14 is transmitted to the inner ring 6b of the second spring 2b. Since the inner rings 6a,6b of the springs 2a,2b are prevented from translational movement by means of their securement to the respective actuator 12, 14, the outer rings 4a,4b move along an axis perpendicular to the planes of the springs 2a,2b. This is the only way in which the rotational force can be transmitted, since the first and second outer rings 4a,4b, although capable of rotation, are subjected to equal but opposite rotational forces from the respective actuators 12, 14. No rotation results because of their securement to the stiffening ring. Thus, it will be understood that the two actuators 12, 14 work in unison. Depending on the overall design of the device, the travel of the outer rings 4a,4b may be anything from about 100 μm up to several centimetres.

If the polarity of the applied voltage is reversed, the outer rings 4a,4b will move along the axis in the opposite direction. The outer rings 4a,4b can be moved between the respective planes of the inner rings 6a,6b of the first and second springs 2a,2b, the exact position of the outer rings 4a,4b being dependent on the polarity and magnitude of the applied voltage to the actuators 12, 14. The actuator assembly is self centring, i.e. will return to the position shown in FIG. 4 when there is no applied voltage thereby obviating the need for a centring spider.

FIG. 6 shows the relationship between rotation and linear travel for the arrangement described with respect to FIGS. 4 and 5. There is a central region having a substantially linear relationship between linear travel and rotation angle, with a tail-off in response at each end of the plot which corresponds to one or other of the springs 2a,2b being in its unstressed state (i.e. inner and outer rings 4a,4b coplanar).

It will be understood that the above configuration allows small angular displacements to be converted into relatively large linear displacements. One particular application for the devices of the present invention is in loudspeaker driver units. FIGS. 7a to 7c are schematic representations of a loudspeaker driver unit in its extreme inner (FIG. 7a), intermediate (FIG. 7b) and extreme outer (FIG. 7c) positions. The driver unit comprises first and second three-arm springs 2a,2b which are similar to that shown in FIG. 1 with θ=100° and D=17 mm, first and second spiral ceramic piezoelectric actuators 12, 14 (made from a 0.6 mm thick tape of PZT-5H (Morgan Electroceramics) having a lateral piezoelectric strain constant of 274 pC/N, inner spiral diameter 3 mm, outer spiral diameter 10 mm and height 4.5 mm) and a hemisphere front piece 20. The arrangement and mounting of the springs 2a,2b and actuators 12, 14 is as described with reference to the embodiment of FIGS. 4 and 5, with each spring 2a,2b being offset from its planar rest position by 5 mm. The rim of the hemisphere front piece 20 is secured to the outer ring 4b of the second spring 2b. The whole assembly is mounted within a cylindrical housing 22 with minimal clearance between the housing 22 and the outer periphery of the outer rings 4a,4b.

The maximum rotation angle from the piezoelectric spiral can be calculated by considering the behaviour of a bimorph tape with a pre-existing curvature. The change in angle subtended per unit turn of such a tape Δθ_{N} can be calculated from:—

$$Δ {θ}_{N} = \frac{4 π ɛ {R}_{m}}{t}$$

where Rₘ is the mean radius of curvature of the tape at rest, t is the total tape thickness and ε the maximum strain developed in the bimorph tape given by
ε=±1.5Ed₃₁
where E is the electric field across each half of the bimorph tape (i.e. 2V/t) where V is the applied voltage, and d₃₁ is the planar coupling coefficient of the piezoelectric material.

The spiral can be considered to be a collection of such curved tapes connected mechanically in series and electrically in parallel. A close approximation of a spiral geometry can be produced by connecting half turns together in the correct number. The overall angular actuation, Δθ, can then be given by adding the individual components together:—

$$Δ θ = {\sum }_{1}^{n} \frac{2 π ɛ {R}_{m , n}}{t}$$

For the spiral described with reference to FIG. 7, the actuation angles for an applied field of 500V/mm are given in Table 1 below. The relationship between linear travel and rotation is plotted in FIG. 8, from which it can be seen that peak to peak displacements of +/−3 mm can theoretically be produced.

TABLE 1

| Half turn | Mean radius, | Angular actuation | Tape |
|---|---|---|---|
| no. | Rₘ/mm | Δθ_{N}/degrees | length/mm |
| 1 | 1.8 | 0.22 | 5.7 |
| 2 | 2.2 | 0.27 | 6.9 |
| 3 | 2.6 | 0.32 | 8.2 |
| 4 | 3.0 | 0.41 | 9.4 |
| 5 | 3.4 | 0.46 | 10.7 |
| 6 | 3.8 | 0.51 | 11.9 |
| 7 | 4.2 | 0.56 | 13.2 |
| 8 | 4.6 | 0.61 | 14.5 |
| Totals | | 3.3 | 80.5 |

Since the arrangement shown in FIG. 7 has good rigidity, no centring mechanism is required and only a small clearance between the hemisphere driver 20 and the surrounding housing 22 is required to isolate effectively the forward acoustic wave from the equal and opposite acoustic wave. In a slightly modified arrangement (not shown), a thin rubber flange is provided between the edge of the hemisphere driver and the surrounding housing. Such a flange seals the unit and provides a centring and balancing force. Since the overall size of the driver unit is small (<25 mm) the unit can function as a full range audio driver with an essentially flat power response from 20 Hz to 20 kHz, the conventionally stated maximum range of human hearing. In a working loudspeaker, the whole driver unit is mounted in a suitable cabinet such as would be used for a conventional magnetic driver. In a further modification (not shown) of the loudspeaker driver unit described, the hemisphere front piece can be replaced by a conical diaphragm.

It will be understood that the described loudspeaker driver unit is light and compact. In addition, conventional electrodynamic loudspeaker drivers require centring spiders and complicated mounting arrangements so that the coil is held rigidly against radial movement in a strong magnetic field whilst being freely moveable axially. Such arrangements inevitably impart excessive stiffness to the assembly, causing extra power losses through damping and hysteresis. Radial movement in the actuator assembly of the present invention is prevented (or at least substantially reduced) due to the inherent high radial stiffness of the plate springs.

Although the arrangement described with reference to FIG. 7 is adequate for most loudspeaker applications, extra stiffening can be provided to prevent tilting of the hemisphere, thereby further improving sound quality. Such an arrangement is shown in FIGS. 8a to 8c (showing extreme inner, intermediate and extreme outer positions respectively). Referring to FIG. 8b, the inner rings 6a,6b of the springs 2a,2b are mounted to the respective actuators 12, 14 adjacent one another, and the outer rings 4a,4b are spaced apart on opposite sides thereof. A cylindrical stiffening collar 24 is adhered at each end to one or other of the outer rings 4a,4b. Upon actuation both outer rings 4a,4b and the stiffening cylinder 24 move in unison.

FIGS. 9a to 9c show an intermediate arrangement having a shorter stiffening collar 26. Thus arrangement offers a compromise between the compactness of the arrangement of FIGS. 7a to 7c and the stiffness of the arrangement of FIGS. 8a to 8c.

Referring to FIG. 10, a low frequency vibration sensor comprises a pair of springs 2a,2b (identical to those described in relation to FIG. 7) whose outer rings 4a,4b are soldered to a stiffening ring as described in relation to FIG. 4. The outer rings 4a,4b are fixedly mounted to the side walls of a housing 30 so that in use, the plane of the springs is horizontal (as shown in FIG. 10). The first and second inner rings 6a,6b are offset by an equal amount above and below the outer rings 4a,4b respectively. The inner ring 6a of the first spring 2a is secured by tabs to the inner curved surface of a spiral transducer 32 (similar to the actuators 12, 14 described with reference to FIG. 7) at its top end, and the inner ring 6b of the second spring 2b is secured by tabs to the outer curved surface of the transducer 32 at its bottom end. It should be noted that unlike the assembly described with reference to FIG. 7, only a single spiral is required (although two spirals arranged in a similar manner to that described with reference to FIG. 7 would work).

The springs 2a,2b and transducer 32 are sealed in the housing 30 by top and bottom end stops 34. The end stops 34 are positioned at a predetermined distance to limit the maximum vertical travel of the transducer 32, to avoid overstressing the device in use. The transducer 32 is connected to a voltage meter located externally of the housing 30 by electrodes (not shown).

In use, as the piezoelectric spiral transducer 32 (and inner rings 6a,6b to which it is secured) is forced to move vertically through the inertial forces applied by a vertical vibration (eg. seismic vibration) through the outer rings 4a,4b, the first and second inner rings 6a,6b will rotate relative to each other, causing the piezoelectric spiral transducer 32 to rotate also. This rotation generates a charge in the piezoelectric spiral transducer 32 proportional to the degree of linear movement of the inner rings 6a,6b relative to the outer rings 4a,4b. The stiffness of the spiral arms 10 and the piezoelectric spiral transducer 32 combined, together with the mass of the moveable transducer portion of the system, will cause the device to exhibit a primary resonant frequency. This resonant frequency can be chosen by altering the geometry of the structure. For seismic sensing applications, this frequency may be chosen to be as low as 10 Hz. The frequency range for measurements may then cover the range from 10 Hz up to several hundred Hz.

Since the piezoelectric device does not require a heavy magnet to function, the overall device can be made much lighter than is the case for a corresponding magnet-coil arrangement. The complexity of the structure can be simplified and the overall size may be reduced for the same response.

Piezoelectric transducers are inherently more efficient than electromagnets, being dependent on electric field rather than current. At rest in any position, a piezoelectrically driven device draws practically no current, whereas the position of a electromagnet driver is related to the magnitude of constant current drawn. Thus, the actuator assembly of the present invention is potentially useful in many applications where electromagnetic drivers are used. The lightweight compact nature of the actuator assembly makes it suitable for any application where mass and size are important considerations. Similar advantages are obtained by the use of the piezoelectric transducer to generate an electrical signal relative to magnet-moving coil systems.

1. A method implemented by a push-to-talk wireless mobile terminal for communicating voice information comprising the steps of:
determining if a request to send a delayed delivery voice message has been made;
if said determining step determines that a request to send a delayed delivery voice message has been made, transmitting an indicator to a communication application server representing an instruction that packets received from the mobile terminal are to be stored for later delivery to a destination Pal;
encoding audio input from a user by the mobile terminal into the packets following the determining step;
transmitting the packets to the communication application server for later delivery to the destination Pal.

2. The method of claim 1 wherein the step of determining if a request to send a delayed delivery voice message has been made comprises sensing that the destination Pal selected by the user to receive the audio input is not available prior to the user initiating the encoding step.

3. The method of claim 2 wherein the step of sensing that the Pal selected by the user as the destination party to receive the audio input is not available comprises the step of determining a current status of the selected Pal stored in the mobile terminal, where the status represents that the selected Pal is not available to receive communications.

4. The method of claim 1 wherein the step of determining if a request to send a delayed delivery voice message has been made comprises determining that an input signal is entered by the user where the input signal represents a request to send said packets as a delayed delivery voice message regardless of whether or not the destination Pal selected to receive the packets is currently available to receive communications.

5. The method of claim 1 wherein the step of transmitting an indicator to a communication application server representing an instruction that the packets are to be stored for later delivery to a destination Pal causes the audio carried by the packets to be stored in the communication application server.

6. The method of claim 5 wherein the instruction further conveys to the communication application server that the packets are not to be attempted to be delivered in real-time to the destination Pal.

7. The method of claim 1 wherein the step of determining if a request to send a delayed delivery voice message has been made comprises the steps of generating a first request for a real-time voice communication to the destination Pal in response to the push-to-talk button being pressed, providing a first alert to the user indicating that a real-time voice communication to the destination Pal is not available, and sensing a second request to initiate communications to the destination Pal by the push-to-talk button being depressed again following the alert having been provided to the user.

8. The method of claim 7 wherein the step of sensing the second request includes sensing the push-to-talk button being depressed again within a predetermined time interval of the first request.

9. The method of claim 7 further comprising the step of providing a second alert to the user in response to the second request wherein the second alert comprises a predetermined talk-beep associated with the request to send a delayed delivery voice message, the predetermined talk-beep comprising an audible alert that is different from an audible alert associated with the initiation of a real-time voice communication.

10. A push-to-talk wireless mobile terminal for communicating voice information comprising:
means for determining if a request to send a delayed delivery voice message has been made;
means for transmitting an indicator to a communication application server representing an instruction that packets received from the mobile terminal are to be stored for later delivery to a destination Pal if said determining means determines that a request to send a delayed delivery voice message has been made;
means for encoding audio input from a user by the mobile terminal into the packets following the determining step;
means for transmitting the packets to the communication application server for later delivery to the destination Pal.

11. The mobile terminal of claim 10 wherein the means for determining comprises means for sensing that the destination Pal selected by the user to receive the audio input is not available to receive real-time communications.

12. The mobile terminal of claim 11 wherein the means for sensing comprises means for determining a current status of the selected Pal stored in the mobile terminal, where the status represents that the selected Pal is not available to receive communications.

13. The mobile terminal of claim 10 wherein the means for determining if a request to send a delayed delivery voice message has been made comprises means for determining that an input signal is entered by the user where the input signal represents a request to send said packets as a delayed delivery voice message regardless of whether or not the destination Pal selected to receive the packets is currently available to receive communications.

14. The mobile terminal of claim 10 wherein the means for transmitting an indicator to a communication application server representing an instruction that the packets are to be stored for later delivery to a destination Pal causes the audio carried by the packets to be stored in the communication application server.

15. The mobile terminal of claim 14 wherein the instruction transmitted by the means for transmitting further conveys to the communication application server that the packets are not to be attempted to be delivered in real-time to the destination Pal.

16. The mobile terminal of claim 10 wherein the means for determining if a request to send a delayed delivery voice message has been made comprises means for generating a first request for a real-time voice communication to the destination Pal in response to the push-to-talk button being pressed, means for providing a first alert to the user indicating that a real-time voice communication to the destination Pal is not available, and means for sensing a second request to initiate communications to the destination Pal by the push-to-talk button being depressed again following the alert having been provided to the user.

17. The mobile terminal of claim 16 wherein the means for sensing the second request includes means for sensing the push-to-talk button being depressed again within a predetermined time interval of the first request.

18. The mobile terminal of claim 16 further comprising means for providing a second alert to the user in response to the second request, the second alert comprises a predetermined talk-beep associated with the request to send a delayed delivery voice message, the predetermined talk-beep comprising an audible alert that is different from an audible alert associated with the initiation of a real-time voice communication.

19. A method implemented by a push-to-talk wireless mobile terminal for communicating voice information comprising the steps of:
displaying a list of Pals of the first user including visual indicia representing that a previously transmitted voice message by the first user to a first Pal is stored and awaits delivery to the first Pal;
determining if a request has been made by the first user to access the stored voice message;
if said request is determined to have been made, discerning the type of access desired by the first user;
transmitting a command to a communication application server at which the voice messages stored where the command conveys instructions to the communication application server to implement action based on the type of access desired by the first user.

20. The method of claim 19 wherein the step of discerning comprises discerning that the stored voice message is to be played back to the first user and wherein the transmitted command conveys instructions to the communication application server to implement transmission of the stored voice message to the first user, the method further comprising the step of receiving at the mobile terminal of the first user the stored voice message previously transmitted by the first user to the first Pal and audibly playing the stored voice message.

21. The method of claim 19 wherein the step of discerning comprises discerning that the stored voice message is to be deleted and wherein the transmitted command conveys instructions to the communication application server to delete the stored voice message previously transmitted by the first user to the first Pal, the method further comprising the step of receiving at the mobile terminal of the first user a signal technology that the stored voice message has been deleted.

22. A push-to-talk wireless mobile terminal for communicating voice information comprising:
means for displaying a list of Pals of the first user including visual indicia representing that a previously transmitted voice message by the first user to a first Pal is stored and awaits delivery to the first Pal;
means for determining if a request has been made by the first user to access the stored voice message;
means for discerning the type of access desired by the first user if said request is determined to have been made;
means for transmitting a command to a communication application server at which the voice messages are stored where the command conveys instructions to the communication application server to implement action based on the type of access desired by the first user.

23. The mobile terminal of claim 22 wherein the means for discerning discerns that the stored voice message is to be played back to the first user and wherein the means for transmitting transmits the command that conveys instructions to the communication application server to implement transmission of the stored voice message to the first user, the mobile terminal further comprising means for receiving, at the mobile terminal of the first user, the stored voice message previously transmitted by the first user to the first Pal and audibly playing the stored voice message.

24. The mobile terminal of claim 22 wherein the means for discerning discerns that the stored voice message is to be deleted and wherein the means for transmitting transmits the command that conveys instructions to the communication application server to delete the stored voice message previously transmitted by the first user to the first Pal, the mobile terminal further comprising means for receiving at the mobile terminal of the first user a signal representing that the stored voice message has been deleted.

25. A method implemented by a push-to-talk wireless mobile terminal for communicating voice information comprising the steps of:
displaying a list of Pals including visual indicia of whether a voice message is waiting for delivery from a Pal;
determining if a request to receive a waiting voice message has been initiated by a user of the mobile terminal;
if said request is determined to have been made, transmitting at least one packet to a communication application server requesting that the waiting voice message associated with a selected Pal be delivered to the user's mobile terminal;
receiving packets at the user's mobile terminal from the communication application server containing the waiting voice message and playing the message to the user.

26. The method of claim 25 wherein the steps of determining if the request has been made comprises sensing that a Pal is selected by the user where the Pal has corresponding visual indicia indicating that a voice message from the Pal is waiting delivery to the user, and sensing an input initiated by the user representing a request to receive delivery of the voice message corresponding to the selected Pal.

27. The method of claim 26 further comprising the steps of receiving a status update following receiving the packets where the status update indicates that there is no longer the voice message from the Pal waiting delivery to the user and updating the visual indicia corresponding to the Pal whose voice message was received to show another visual indicia representing that the voice message is no longer waiting delivery to the user.

28. A push-to-talk wireless mobile terminal for communicating voice information comprising:
means for displaying a list of Pals including visual indicia of whether a voice message is waiting for delivery from a Pal;
means for determining if a request to receive a waiting voice message has been initiated by a user of the mobile terminal;
means for transmitting at least one packet to a communication application server requesting that the waiting voice message associated with a selected Pal be delivered to the user's mobile terminal if said request is determined to have been made;
means for receiving packets at the user's mobile terminal from the communication application server containing the waiting voice message and playing the message to the user.

29. The mobile terminal of claim 28 wherein the means for determining if the request has been made comprises means for sensing that a Pal is selected by the user where the Pal has corresponding visual indicia indicating that a voice message from the Pal is waiting delivery to the user, and means for sensing an input initiated by the user representing a request to receive delivery of the voice message corresponding to the selected Pal.

30. The mobile terminal of claim 29 further comprising means for receiving a status update following receiving the packets where the status update indicates that there is no longer the voice message from the Pal waiting delivery to the user and means for updating the visual indicia corresponding to the Pal whose voice message was received to show another visual indicia representing that the voice message is no longer waiting delivery to the user.

31. A method implemented by a communication application server in a packet communication network for processing communications comprising the steps of:
receiving a first packet from a mobile terminal of a user;
determining if the first packet contains an indicator representing an instruction to process any following voice packets as a delayed delivery voice message;
receiving a set of voice packets from a mobile terminal of a user;
if said determining step determines that said indicator is present, storing at least payloads of the voice packets of said set in memory and labeling the stored payloads as addressed to a destination Pal identified by said set of packets.

32. The method of claim 31 further comprising the step of attempting to deliver voice information contained in said payloads only upon receiving a command from a mobile terminal of the destination Pal where the command corresponds to input initiated by the Pal to retrieve the stored voice information.

32. The method of claim 31 further comprising the steps of generating a status update following the storing step and transmitting the status update to at least the mobile terminals of the destination Pal and the user.

33. The method of claim 32 wherein the step of transmitting the status update comprises transmitting a status update to the destination Pal indicating that the voice information from the user is awaiting deliver to the destination Pal and transmitting a status update to the user indicating that the voice information from the user to the destination Pal is still awaiting delivery to the destination Pal.

34. The method of claim 32 further comprising the step of receiving said command from the mobile terminal of the destination Pal, retrieving the at least voice information payloads, encoding the at least voice information payloads into further packets addressed to the destination Pal, and transmitting the further packets to the destination Pal.

35. The method of claim 34 further comprising the steps of generating a status update following the transmitting of the further packets and transmitting the status update to at least the mobile terminals of the destination Pal and the user, where the status update represents that the voice information has been delivered to the destination Pal.

36. The method of claim 35 wherein the step of transmitting the status update comprises transmitting a status update to the destination Pal indicating that there is no longer the voice information from the user awaiting deliver to the destination Pal and transmitting a status update to the user indicating that there is no longer the voice information from the user awaiting delivery to the destination Pal.

37. A communication application server in a packet communication network for processing communications comprising:
means for receiving a first packet from a mobile terminal of a user;
means for determining if the first packet contains an indicator representing an instruction to process any following voice packets as a delayed delivery voice message;
means for receiving a set of voice packets from a mobile terminal of a user;
means for storing at least payloads of the voice packets of said set in memory and labeling the stored payloads as addressed to a destination Pal identified by said set of packets if said determining step determines that said indicator is present.

38. The communication application server of claim 37 further comprising means for attempting to deliver voice information contained in said payloads only upon receiving a command from a mobile terminal of the destination Pal where the command corresponds to input initiated by the Pal to retrieve the stored voice information.

39. The communication application server of claim 37 further comprising means for generating a status update following the storage of the at least payloads and means for transmitting the status update to at least the mobile terminals of the destination Pal and the user.

40. The communication application server of claim 39 wherein the means for transmitting the status update comprises means for transmitting a status update to the destination Pal indicating that the voice information from the user is awaiting delivery to the destination Pal and means for transmitting a status update to the user indicating that the voice information from the user to the destination Pal is still awaiting delivery to the destination Pal.

41. The communication application server of claim 39 further comprising means for receiving said command from the mobile terminal of the destination Pal, means for retrieving the at least voice information payloads, means for encoding the at least voice information payloads into further packets addressed to the destination Pal, and means for transmitting the further packets to the destination Pal.

42. The communication application server of claim 41 further comprising means for generating a status update following the transmitting of the further packets and means for transmitting the status update to at least the mobile terminals of the destination Pal and the user, where the status update represents that the voice information has been delivered to the destination Pal.

43. The communication application server of claim 42 wherein the means for transmitting the status update comprises means for transmitting a status update to the destination Pal indicating that there is no longer the voice information from the user awaiting deliver to the destination Pal and means for transmitting a status update to the user indicating that there is no longer the voice information from the user awaiting delivery to the destination Pal.
